(19) United States
(12) Patent Application Publication
(10) Pub. No.: US 2009/0246104 A1
(43) Pub. Date: Oct. 1, 2009

(54) Precipitation of Gibbsite from a Bayer Liquor

(76) Inventors: Linda Jane McCausland, Oxfordshire (GB); Martin Fennell, Co.Clare (IE)

Correspondence Address: LAW OFFICES OF WILLIAM H. HOLT, 12311 HARBOR DRIVE, WOODBRIDGE, VA, 22192, US

(21) Appl. No.: 11/629,894

(22) PCT Filed: Jun. 17, 2005
(86) PCT No.: PCT/GB2005/050092

§ 371 Date: Oct. 15, 2008

(30) Foreign Application Priority Data
Jun. 17, 2004 (GB) 0413511.7

(51) Int. Cl. C01F 7/14; B01D 43/00

(52) U.S. Cl. 423/124; 422/255

(57) ABSTRACT

A Bayer liquor is produced by dissolving bauxite in hot caustic soda. The liquor is cooled so that it is supersaturated, and seed crystals of gibbsite are added to the liquor (16). At the same time at least part of the liquor is subjected to intense ultrasonic irradiation (34) such as to cause cavitation, preferably by passing liquor and seed crystals (28) through a recirculation duct (30). The ultrasound increases the proportion of fines by breaking up any crystal agglomerates and also by generating crystal nuclei, and also removes fouling from crystal surfaces. The precipitation process is consequently more effective. If ultrasound is applied when measurements indicate that there are insufficient fines in the liquor, this improves the consistency of the precipitation process.

This invention relates to a process and apparatus for precipitating gibbsite from a Bayer liquor.

The Bayer process is a widely used process for obtaining pure alumina from bauxite ore. It involves treating the ore with hot sodium hydroxide solution at say 150° C., so alumina dissolves to form sodium aluminate, leaving other minerals from the ore in the form of red mud. The saturated sodium aluminate solution is cooled, and seeded with aluminium trihydroxide crystals (Al(OH)₃), which may be referred to as gibbsite or alumina trihydrate (Al₂O₃3H₂O). The alumina in solution precipitates as gibbsite, and can then be calcined at say 1050° C. to form pure alumina. The remaining solution, which may be referred to as Bayer liquor, can be recycled to treat fresh ore, after addition of any necessary sodium hydroxide to ensure it is concentrated enough.

The precipitation is however very slow, so that very large volume storage tanks are typically employed to promote secondary nucleation and growth. In order to accelerate the nucleation of the gibbsite it is typically necessary to recycle as much as 80% of the gibbsite obtained, after separation, to use as seed crystals. This is partly due to the slow kinetics of the crystallisation, and also due to the buildup of organic contaminants which foul the surfaces of the seed crystals. Such organic contaminants may originate from the ore, or may be formed by caustic degradation of other organic compounds from the ore.

According to the present invention there is provided a process for precipitating gibbsite from a Bayer liquor, the process comprising cooling the Bayer liquor so that it is supersaturated, adding seed crystals of gibbsite to the liquor, and at the same time subjecting at least part of the liquor to intense ultrasonic irradiation to cause cavitation.

Preferably the seed crystals are obtained by recycling gibbsite produced by the process, and are also subjected to intense ultrasonic irradiation. This tends to reduce the fouling present on their surfaces, which improves the yield of the process.

The presence of fine crystals as seed crystals is desirable. Such fine crystals are normally produced by a secondary nucleation process occurring on the surfaces of existing gibbsite crystals, and these small crystal nuclei are then broken off the parent crystal by attrition. The ultrasonic irradiation has the effect of both generating small crystal nuclei (arising from cavitation events), and also breaking off any small crystals from the surfaces of existing gibbsite crystals and so increasing the proportion of fines.

It can be expected that, in the presence of the ultrasound, crystal nuclei will form with less supersaturation than is usually required. This decreases the inclusion of impurities such as sodium ions in the resulting gibbsite crystals. Furthermore the process of the invention reduces the proportion of product crystals that must be recirculated as seed crystals. This proportion is preferably less than 70%, and may be as low as 50% or even less.

Preferably a stream of the liquor is subjected to ultrasonic irradiation by causing the stream to flow through a duct, and continuously subjecting the contents of the duct to ultrasonic irradiation. The ultrasound may be applied using a multiplicity of ultrasonic transducers attached to a wall of the duct in an array of separate transducers extending both circumferentially and longitudinally, each transducer being connected to a signal generator so that the transducer radiates no more than 3 W/cm², the transducers being sufficiently close together and the number of transducers being sufficiently high that the power dissipation within the vessel is between 25 and 150 W/litre. Preferably the duct is of width at least 0.10 m, that is to say if the duct is cylindrical it is of diameter at least 0.10 m. The values of power. given here are those of the electrical power delivered to the transducers, as this is relatively easy to determine. Such an irradiation vessel is described in WO 00/35579. With such a vessel there is little or no cavitation at the surface of the wall, so that there is no erosion of the wall and consequently no formation of small particles of metal.

Preferably the ultrasound is supplied by a multiplicity of transducers coupled to the wall of a pipe carrying the supersaturated solution, the liquor flowing at such a rate that the solution is insonated for less than 2 s on each pass through the pipe.

The treatment to make the solution supersaturated may for example involve cooling to between 85° C. and 50° C., although the requisite temperature depends upon the initial concentration of the solution being cooled.

The invention also provides an apparatus for performing this method.

The invention will now be further and more particularly described by way of example only and with reference to the accompanying drawing, in which:

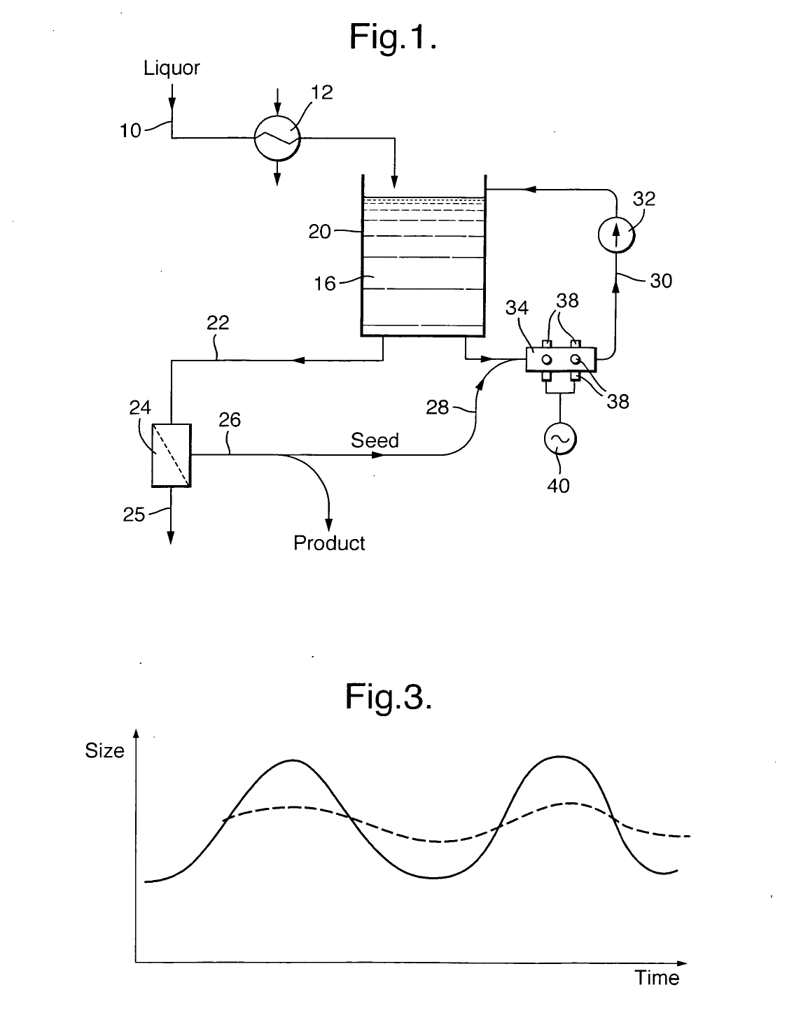

FIG. 1 shows a flow diagram of plant for crystallising gibbsite from Bayer liquor;

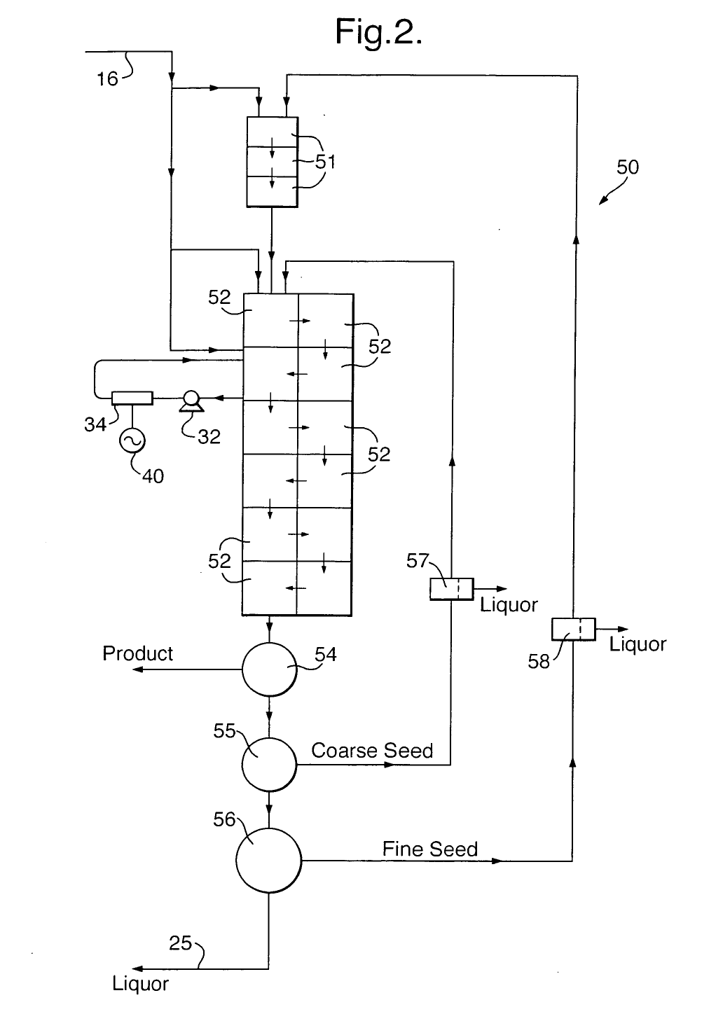

FIG. 2 shows a flow diagram of an alternative, larger-scale plant for crystallising gibbsite from Bayer liquor; and

FIG. 3 shows graphically the variation in mean crystal size, with time, in operation of such a plant, with and without provision of the ultrasonic treatment of the invention.

Referring to FIG. 1, bauxite ore is dissolved in a caustic solution of between 4 M and 5 M sodium hydroxide and at a temperature between 140° C. and 290° C., depending upon the exact nature of the ore. This produces a caustic solution 10 containing sodium aluminate, which may be referred to as a Bayer liquor. The Bayer liquor 10 is cooled, through heat exchangers 12 (for example ending up at 70° C.), so that the resulting liquor 16 is significantly supersaturated at least as regards alumina trihydrate (gibbsite). However the gibbsite tends not to come out of solution readily, partly because of the organic material in solution. The liquor 16 is then supplied to a hold-up tank 20. A product slurry 22 comprising precipitated gibbsite and Bayer liquor is tapped off from the base of the tank 20 and is supplied to a filtration unit 24 such as a belt filter, and the filtrate 25 (which primarily consists of caustic soda) can be returned to the process stream used for dissolving bauxite.

The filter cake 26 of gibbsite crystals is partly removed as the desired product, and the remainder 28 is used as seed for the precipitation process. The hold-up tank 20 is provided with a recirculation loop 30 tapping off from the base of the tank 20 and feeding back into the tank 20 near the top. This loop includes a recirculation pump 32 and an ultrasonic irradiation duct 34, and the seed crystals 28 are introduced into the recirculation loop 30 upstream of the irradiation duct 34. The loop 30 is shown diagrammatically, and the flow paths may typically be of nominally six inch (150 mm) diameter pipe, and the ultrasonic irradiation duct 34 may comprise a stainless-steel duct of the same internal diameter.

The ultrasonic duct 34 includes ten transducer modules 38 in a regular array attached to the outside of a duct. Each transducer module 38 comprises a 50 W piezoelectric transducer which resonates at 20 kHz, attached to a conically flared aluminium coupling block by which it is connected to the duct wall, the wider end of each block being of diameter 63 mm. The transducer modules 38 are arranged in two circumferential rings each of five modules 38, the centres of the coupling blocks being about 105 mm apart around the circumference, and about 114 mm apart in the longitudinal direction. A signal generator 40 drives all the transducer modules 38.

With this ultrasonic duct 34 the power intensity is only about 1.6 W/cm², and is such that cavitation does not occur at the surface of the wall, so erosion of the surface does not occur. Nevertheless the power density is sufficient to ensure nucleation in a saturated solution. The volume of liquid which is subjected to insonation is about 5 l, so the power density is about 100 W/litre. (The power density can be adjusted by adjusting the power supplied to the transducer modules 38, but is usually between 40 and 100 W/litre.)

The flow rate through the ultrasonic treatment loop 30, and so through the duct 34, may for example be such that the liquor is insonated for a period between 1 s and 10 s, for example about 3 s. A larger quantity of liquor can be treated (per unit time), by using a longer irradiation duct of the same diameter, with more circumferential rings of five modules 38 each, the rings being spaced apart by 114 mm centre to centre in the longitudinal direction, as described in relation to the drawing. For example, using a duct with twenty such circumferential rings of five modules 38, and so with an insonation volume about ten times that of the duct shown in the drawing, the same insonation time can be achieved with a ten times increase in flow rate.

The effect of the ultrasound on the slurry passing around the loop 30 is to prevent agglomeration of crystals, to remove any small crystal nuclei from the surfaces of the larger crystals, and to remove or inhibit the buildup of organic material on the surfaces of the crystals, and also to generate crystal nuclei by cavitation. The overall result is an increased proportion of fines, and crystals with cleaner surfaces, so that the crystallisation process within the hold-up tank 20 proceeds more effectively. Consequently a smaller proportion of the product has to be recycled as seed crystals 28 compared to conventional processes: this proportion may be only 75% or even as little as 50%. Furthermore the crystallisation or precipitation process can be carried out with less supersaturation, so that purer gibbsite crystals are formed with less impurity inclusion (such as sodium ions), and the process is thermally more efficient as somewhat less cooling is required.

The plant of FIG. 1 is somewhat simplistic. Referring to FIG. 2, in which identical features are referred to by the same reference numerals, in a practical plant 50 the supersaturated liquor 16 is supplied to two series of hold-up tanks: in this example there are three tanks that are referred to as agglomeration tanks 51, through which liquor 16 passes in succession, and then twelve tanks referred to as precipitation tanks 52 through which liquor passes in succession, the first precipitation tank 52 being fed with the outflow from the third agglomeration tank 51. Some of the supersaturated liquor 16 is fed directly into the first agglomeration tank 51, and the rest is fed into the precipitation tanks 52, mostly into the first tank 52 and in this case some into the fourth precipitation tank 52. A suspension of alumina trihydrate particles in Bayer liquor emerges from the last precipitation tank 52, and is subjected to three successive separation steps, for example relying on separation by gravity. The first stage separator 54 separates off the largest particles, and these may be supplied to a calciner to produce alumina. The second stage separator 55 separates off coarse seed particles which are fed back to the first precipitation tank 52, while the third stage separator 56 separates off all remaining fine particles, which are fed back as fine seed particles to the first agglomeration tank 51. The remaining liquor 25 can be returned to the process stream used to dissolve bauxite.

It will be appreciated that this plant 50 is described by way of example only, and that in particular the numbers of agglomeration tanks 51 and precipitation tanks 52 may differ. The numbers of tanks 51 and 52 and their sizes will clearly depend on the required throughput of liquor. Preferably the residence time in the tanks 51 and 52 is at least 24 hours, and may be more than 36 hours, to allow time for the slow precipitation processes to occur.

The coarse seeds and the fine seeds are fed back as suspensions in liquor, and each feed-back duct is also provided with a cross-flow filter 57, 58 so a proportion of this liquor can be withdrawn, and can be combined with the liquor 25.

Referring now to FIG. 3, the mean particle size of alumina trihydrate particles produced by such a plant 50 has been found to be unstable, and to vary over a timescale of days or weeks, as indicated by the full line. Similar size variations would be found in any one of the precipitation tanks 52, although the numerical size values and phasing would differ from tank to tank. Consistent output is therefore very difficult to achieve. It is believed that this oscillation occurs for the following reasons. If the particle sizes become coarse, then their surface area decreases, and the degree of supersaturation therefore increases; this leads to increased auto-nucleation, with the generation of fines, so that the particle size tends to decrease. But if the particle sizes become fine, their surface area increases, so that the degree of supersaturation decreases, so that less auto-nucleation occurs; this leads to the formation of coarser particles.

Referring again to FIG. 2, some of the contents from the fourth precipitation tank 52 are recirculated by a pump 32 through an insonation duct 34 as described in relation to FIG. 1, out from near the base of the tank 52 and back into the top of the tank 52. In addition, the particle sizes in the fourth tank 52 are monitored, for example by a laser monitoring equipment (e.g. Lasentec™). The signal generator 40 for this duct 34 is activated when the mean particle size exceeds a threshold value. The effect of the ultrasonic treatment is to create additional fines, typically of size about 10-15 μm (after an induction time which may be about half an hour), so preventing the mean size continuing to rise. Hence, as indicated by the broken line in FIG. 3, the range of fluctuations of the particle sizes is reduced.

It will be appreciated that the insonation duct 34 may be actuated in response to measurements of particle size made in a different way, for example by sampling. And as another alternative, the insonation may be actuated in response to measurements of the concentation of sodium aluminate in the liquor: if the degree of supersaturation increases above a threshold value, that indicates that insufficient auto-nucleation is occurring, and actuating the insonation duct 34 can rectify this.

The insonation duct 34 is actuated for sufficiently long to bring about a significant change in the particle size distribution in the tank 52, and the generator 40 is then switched off. For example it may be actuated for a fixed period of time (which will depend upon the volume of the tank 52, and may for example be six hours). Alternatively it may be actuated for a sufficient length of time that the monitored parameter, e.g. the mean particle size, has dropped below a threshold value.

1-10. (canceled)

11. A process for precipitating gibbsite from a Bayer liquor, said process comprising the steps of cooling the Bayer liquor so that it is supersaturated, and supplying the supersaturated liquor to a first plurality of agglomeration tanks through which said supersaturated liquor passes in succession, feeding the first precipitation tank with outflow from the last agglomeration tank, wherein the process further comprises adding fine seed particles of gibbsite to the liquor in the first of the agglomeration tanks, and at the same time subjecting at least part of the liquor from one of the precipitation tanks to intense ultrasonic irradiation to cause cavitation, and applying the ultrasonic irradiation in response to measurements indicating an insufficient number of fines.

12. A process as claimed in claim 11 wherein coarse seed particles of gibbsite are added to the liquor in the first of the precipitation tanks.

13. A process as claimed in claim 11 wherein a stream of the liquor is subjected to ultrasonic irradiation by causing the stream to flow through a duct, and continuously subjecting the contents of the duct to ultrasonic irradiation.

14. A process as claimed in claim 13 wherein the ultrasonic irradiation takes place within a recirculation duct.

15. A process as claimed in claim 11 wherein, in response to the measurements, the ultrasonic irradiation is carried out for a fixed period of time sufficient to bring about a significant change in the particle size distribution, and then stopped.

16. A process as claimed in claim 11 wherein the measurements are of particle sizes in the liquor.

17. A process as claimed in claim 11 wherein the measurements are of the concentration of sodium aluminate in the liquor.

18. Apparatus for performing a process as claimed claim 11.

19. Apparatus as claimed in claim 18 wherein the ultrasound is applied using a multiplicity of ultrasonic transducers attached to a wall of a duct in an array of separate transducers extending both circumferentially and longitudinally, each transducer being connected to a signal generator so that the transducer radiates no more than 3 W/cm², the transducers being sufficiently close together and the number of transducers being sufficiently high that the power dissipation within the vessel is between 25 and 150 W/litre.
